(19) United States
(12) Patent Application Publication
(10) Pub. No.: US 2022/0241130 A1
(43) Pub. Date: Aug. 4, 2022

(54) DEVICE FOR RELIEVING THE LOAD ON THE HUMAN MUSCULOSKELETAL SYSTEM DURING WORK OR LEISURE

(71) Applicant: Aleksandr Viktorovich ZELENIN, Izhevsk (RU)

(72) Inventor: Aleksandr Viktorovich ZELENIN, Izhevsk (RU)

(21) Appl. No.: 17/612,271

(22) PCT Filed: Apr. 9, 2020
(86) PCT No.: PCT/RU2020/000191

§ 371 Date: Nov. 18, 2021

(30) Foreign Application Priority Data
Oct. 22, 2019 (RU) 2019133725

(51) Int. Cl. A61H 1/02

(52) U.S. Cl. CPC A61H 1/0229; A61H 2201/1642; A61H 2203/0406; A61H 2201/0192; A61H 2201/1638; A61H 2201/1676

(57) ABSTRACT

The invention relates to the field of medicine. A device for relieving the load on the human musculoskeletal system during work or leisure comprises a base, a supporting bed mounted at an angle to the base, a foot rest and a spring mechanism. The spring mechanism allows the support bed to rock relative to the base. The device is equipped with a rocking force adjustment mechanism, as well as with height-adjustable armrests and a table. The table is adjustable with respect to its position relative to a person. This provides for an improvement in the performance of the device for users of different builds, allows users to be more comfortably accommodated irrespective of their height or weight, improves levels of efficiency, reactivity and endurance in users, and provides a greater sensation of well-being and relaxation than sitting.

### TECHNICAL FIELD OF THE INVENTION

The invention relates to the field of human life, namely, leisure and unloading furniture designed for people who are forced to be in a sitting or standing position for a long time, as well as for the preventive treatment and maintenance of the vitality of a spine and joints of a musculoskeletal system.

### BACKGROUND OF THE INVENTION

One of the reasons for a person's loss of energy and the occurrence of fatigue is muscle tension, which contributes to the occurrence of various diseases. The best rest for a tired body is relaxation, which helps one relieve tension and revive vitality. A tired person intuitively finds such a body position, which is the best way to provide a tense body with relaxation and good rest. Self-balancing allows a tired body to relax and revive. Cinema, theater and circus artists, lecturers, teachers, and athletes need, before performances, to unload a musculoskeletal system and quickly revive the body.

RU 2536716 discloses a device for providing a health-improving effect on a human body, which comprises at least one support, a seat mounted on the support, and at least one means providing an oscillatory motion of the seat. The device is characterized in that it comprises at least one barrel-shaped or conical helical spring providing the oscillatory motion of the seat along vertical and horizontal axes and a rotation about the vertical and horizontal axes with a frequency of 1 to 5 Hz. The spring has a first end connected to the support and a second end connected to a lower surface of the seat. The device is intended to be accommodated by a person such that there is a natural health-improving effect on the human body during work or leisure due to oscillations arising from any natural movements of the person himself, without having to use means for external oscillatory impact and thereby maintaining an equilibrium, balanced, comfortable state of the human body in any position it takes.

There also exists a Lean Chair (http://laanchair.com), which comprises a base, a support bed mounted at an angle to the base, and a footrest. With the Lean Chair, one can work in semi-upright and semi-recumbent positions. In this case, the weight of a human body is partly transferred from a lower part of the body to the support bed, on which a user back rests, as well as soft support of the body is provided with a slight tilt backward, thereby significantly reducing a load on legs.

RU 178499 discloses a device for resting and unloading a musculoskeletal system, which comprises a base, a support bed mounted at an angle to the base, and a footrest. The device is characterized in that it is equipped with: —a rocking fastening assembly which causes the support bed to rock relative to a transverse horizontal axis in a vertical plane and comprises at least one leaf spring attached to the fixed base at one end and to the support bed at another end; and—a rocking angle limiter made as a leaf spring cantilevered on the base and configured to interact with a rear surface of the support bed. The position of a person on the device may be both in a calm (static) state and in a rocking state. The transverse body-rocking natural for a person has a beneficial effect on the person, strengthening the vestibular system, providing vessel massage, stimulating the functions of both brain hemispheres, eliminating congestive phenomena and, thus, improving the functioning of the whole body. This technical solution was adopted as a prototype of the claimed invention.

A common disadvantage of all the prior art devices, including the prototype, for unloading the musculoskeletal system of a person during work or leisure is that they do not provide the possibility of human-body self-balancing and sufficiently comfortable conditions for human-body accommodation depending on the height and weight of the person, which prevents effective relaxation and does not provide a full opportunity to work or leisure.

### SUMMARY OF THE INVENTION

The objective of the invention is to improve device performance for users of different builds and allow a user to be more comfortably accommodated irrespective of his/her height or weight.

The essence of the invention is expressed as the following set of essential features sufficient to solve the technical problem indicated by the applicant and obtain the technical result provided by the invention.

According to the invention, a device for unloading a musculoskeletal system of a person during work or leisure comprises a base, a support bed mounted at an angle to the base, a footrest, and a spring mechanism configured to rock the support bed relative to the base. The device is characterized in that it is equipped with a rocking force adjustment mechanism, as well as height-adjustable armrests and a table which is position-adjustable relative to the person.

The invention is further characterized by the presence of a set of additional optional features, namely:
the rocking force adjustment mechanism may be configured as an adjustable stop that changes a rocking force of the spring mechanism;
the table may be height-adjustable;
the table may be inclination-adjustable;
the table may be adjustable in distance from the support bed;
the support bed may be equipped with a height-adjustable headrest.

The applicant has not found information sources containing data about technical solutions comprising sets of features which would comply with the set of distinguishing features of the invention. For this reason, it may be concluded that the invention meets the patentability requirement of novelty (N).

The set of essential features of the invention ensures the technical result which consists in that the rocking force adjustment mechanism allows people of different builds to select a suitable rocking force providing the best conditions for person capacity or his/her effective leisure, while the adjustable armrests and the table allow a user to be more comfortable accommodated irrespective of his/her height or weight.

This technical result is not a consequence of the well-known properties manifested by the set of features separately known from the prior art, such as the support bed. Instead, it is a property provided only by the whole set of essential features comprised in the independent claim. This allows the invention to be considered compliant with the patentability requirement of inventive step (IS).

### BRIEF DESCRIPTION OF THE DRAWING

The essence of the invention is explained by the drawing which shows its general view.

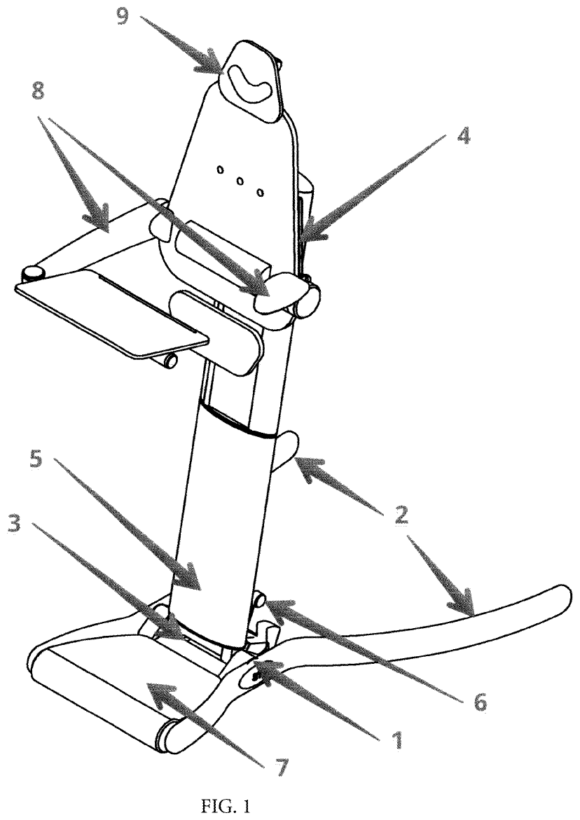

In the drawing FIG. 1, there are reference numerals denoting: 1—base beam; 2—base, 3—spring mechanism, 4—armrest and table position adjustment mechanism, 5—support bed, 6—support-bed inclination limiter, 7—footrest, 8—armrests, 9—headrest.

### DETAILED DESCRIPTION OF THE INVENTION

After a person accommodates his back, pelvis, and hips on a support bed 5, and his feet on a footrest 7, reflex work of body muscles (self-balancing) begins in order to provide the most comfortable and balanced body posture. The support bed 5, which is mounted with the ability to rock, forces the person to balance, thereby facilitating spontaneous adoption of a comfortable posture. A rocking force adjustment mechanism, which may be configured as an adjustable stop that changes the force of a spring mechanism 3, adjusts this force to the constitution of the person. Adjustable armrests 8, a headrest 9, and a table allow the person to be accommodated more comfortably, while an inclination limiter 6 limits a maximum rocking angle of the support bed 4 and at the same time functions as a shock absorber.

The position of the person on the device may be both in a calm (static) state and in a rocking state. Rocking is carried out due to self-balancing and light repulsion of feet from the footrest 7. The applied force adjusts the amplitude of an oscillatory motion. At the same time, core muscles remain in a calm, relaxed state. The transverse body-rocking natural for a person has a beneficial effect on the person, strengthening the vestibular system, providing vessel massage, stimulating the functions of both brain hemispheres, eliminating congestive phenomena and, thus, improving the functioning of the whole body during work or leisure.

### INDUSTRIAL APPLICABILITY

The proposed device may be manufactured industrially by using known technical means and technologies, which ensures its coincidence with the patentability requirement of industrial applicability.

The study of the device, which was conducted at the Federal State Budgetary Educational Institution of Higher Education “Izhevsk State Medical Academy” of the Ministry of Health of Russia, confirmed that the device is advantageous for physical and psychological relaxation during the labor process among students. At the same time, it was documented that the indicators of working efficiency, warming-up and endurance are improved, while the general well-being and relaxation of a worker are improved to a greater extent than when resting in a sitting position. Recommendations for implementing the device into the organization's workflow were given.

What is claimed is:

1. A device for unloading a musculoskeletal system of a person during work or leisure, comprising:
a base,
a support bed mounted at an angle to the base,
a footrest, and
a spring mechanism configured to rock the support bed relative to the base,
wherein the device further comprises a rocking force adjustment mechanism, as well as height-adjustable armrests and a table, the table being position-adjustable relative to the person.

2. The device according to claim 1, wherein the rocking force adjustment mechanism is made as an adjustable stop configured to change a rocking force of the spring mechanism.

3. The device according to claim 1, wherein the table is height-adjustable.

4. The device according to claim 1, wherein the table is inclination-adjustable.

5. The device according to claim. 1, wherein the table is adjustable in distance from the support bed.
